(19) United States
(12) Patent Application Publication
(10) Pub. No.: US 2008/0092699 A1
(43) Pub. Date: Apr. 24, 2008

(54) Wallboard screw with bi-tapered socket for receiving a bi-tapered screw driver tip

(76) Inventor: Matt F. Surowiecki, Seattle, WA (US)

Correspondence Address: BARNARD INTELLECTUAL PROPERTY LAW, INC., P.O. BOX 58888, SEATTLE, WA, 98138-1888, US

(21) Appl. No.: 11/586,166

(22) Filed: Oct. 24, 2006

(51) Int. Cl. B25B 15/00; B25B 23/00

(52) U.S. Cl. 81/460; 81/436

(57) ABSTRACT

A screw driver (40) having a bi-tapered driver tip fits into a bi-tapered screw driver tip receiving socket in a screw (42). The outer taper on the driver tip and the outer taper in the driver tip receiving socket in the screw are complementary to each other and each have a taper angle of substantially about 40°-50°, with substantially about 45° being the preferred angle. The inner portions of the driver tip and the driver tip receiving socket are also complementary portions. They have a taper angle of substantially about 25°-35° with substantially about 30° being the preferred taper angle. The screw driver tip and the tip receiving socket have four grooves spaced substantially 90° apart and four ridges space substantially 90° apart. The ridges on the screw driver tip enter into the grooves in the screw driver receiving socket in the screw and the ridges in the socket in the screw are received with the grooves formed in the screw driver tip. This construction of the screw driver tip and the screw driver tip receiving socket in the screw is closely patterned after the well-known “Phillips” screw and screw driver.

### TECHNICAL FIELD

The present invention relates to improvements in screws of the type used for securing wallboard or the like to metal framing members. More particularly, it relates to the provision of a wallboard screw that has a bi-tapered socket for receiving a complementary bi-tapered screw driver tip, for providing increased contact area between the screw driver tip and the socket in the screw.

### BACKGROUND OF THE INVENTION

Example wallboard screws that exist in the patent literature are disclosed by U.S. Pat. No. 5,203,657, granted Apr. 20, 1993, to Eiichi Nagoshi, Osami I. Wasaki and Tetuya Aksshi; by U.S. Pat. No. 5,205,694, granted Apr. 27, 1993, to Eiichi Nagoshi, Osami I. Wasaki and Tetuya Aksshi; by U.S. Pat. No. 5,890,860, granted Apr. 6, 1999, to Kenneth L. Dorris; and by U.S. Pat. No. 6,116,834, granted Sep. 12, 2000, to Kenneth L. Dorris.

U.S. Pat. Nos. 5,890,860 and 6,116,834 disclose extending the screw driver tip receiving socket into the shank of the screw and providing no driving engagement between the screw driver tip and the head of the screw. U.S. Pat. Nos. 5,203,657 and 5,205,694 show the screw driver tip receiving socket being located only in the head of the screw. A disadvantage of placing the socket only in the shank portion of the screw is that the room available in the shank provides for a small socket, which can only receive a small screw driver tip. A disadvantage of placing the screw driver tip receiving socket only in the head of the screw is that the socket is very shallow and the area of driving engagement is small for that reason.

There is a need for providing a screw that will engage a substantial part of the turning surfaces on the screw driver tip and make it possible to increase the area of turning surfaces on the screw driver tip. A principal object of the present invention is to fill this need.

### BRIEF SUMMARY OF THE INVENTION

An object of the invention is to provide an improved wallboard screw of the type comprising a head part including a screw driver tip receiving socket and a shank part including threads. According to an aspect of the invention, this screw is improved by providing it with a screw driver tip receiving socket that is bi-tapered and is adapted to receive a bi-tapered driver tip. The bi-tapered socket includes an inner socket portion having a first taper angle and an outer socket portion having a second, larger taper angle. The inner socket portion extends into the shank from the head. The outer and inner socket portions each have alternating grooves and ridges, with the grooves in the outer socket portion merging with the grooves in the inner socket portion, and with the ridges in the outer socket portion merging with the ridges in the inner socket portion.

The screw may be a self-tapping screw or be a standard screw that screws into a pre-drilled hole in the framing member that receives it.

The taper angle of the inner socket portion may be substantially about 25°-35°, with substantially about 300 being the preferred taper angle. The taper angle of the outer socket portion may be substantially about 40°-50°, with the preferred taper angle being substantially about 45°.

The screw may have a bugle head and it may have a dished outer end that is surrounded by a rounded rim.

The bi-tapered socket receives a complementary bi-tapered tip of a screw driver. At its inner end, the socket is extended into the shank. This increases the area of the turning surfaces and allows the use of larger turning surfaces in the outer portion of the socket and smaller turning surfaces extending into the shank portion of the socket.

Other objects, advantages and features of the invention will become apparent from the description set forth below, from the drawings and from the principles that are embodied in the specific structures that are illustrated and described.

### BRIEF DESCRIPTION OF SEVERAL VIEWS OF THE DRAWINGS

Like reference numerals refer to like parts throughout the several views of the drawing, and:

FIG. 1 is an elevational view of a prior art wallboard screw with a portion of the head of the screw shown in section and with the ridges and grooves in the driver tip socket omitted;

FIG. 2 is a top plan view of the screw shown by FIG. 1, such view including the ridges and grooves in the driver tip socket;

FIG. 3 is a fragmentary sectional view of the screw shown by FIGS. 1 and 2, such view showing the ridges and grooves in the driver tip socket;

FIG. 4 is an elevational view of a first, small size prior art screw driver tip;

FIG. 5 is a view like FIG. 4, but showing a second, larger size prior art screw driver tip;

FIG. 6 is an elevational view of the screw driver tip shown by FIG. 5, and showing superimposed on it, in phantom lines, the screw driver tip of FIG. 4;

FIG. 7 is an elevational view of a new driver tip combining the screw driver tip shown by FIGS. 5 and 6 and the end portion only of the screw driver tip shown by FIGS. 4 and 6;

FIG. 8 is a fragmentary elevational view of the lower end portion of the screw driver tip shown by FIG. 7, such view indicating the different tapers of inner and outer portions of such tip;

FIG. 9 includes a fragmentary elevational view of a screw having a bi-tapered screw driver tip receiving socket sized to receive the bi-tapered screw driver tip shown by FIG. 7, such screw driver tip being spaced axially out from the socket; and

FIG. 10 is a view like FIG. 9, but showing the bi-tapered screw driver tip moved axially into engagement with the bi-tapered screw driver tip receiving socket in the screw.

### DETAILED DESCRIPTION OF THE ILLUSTRATED EMBODIMENT

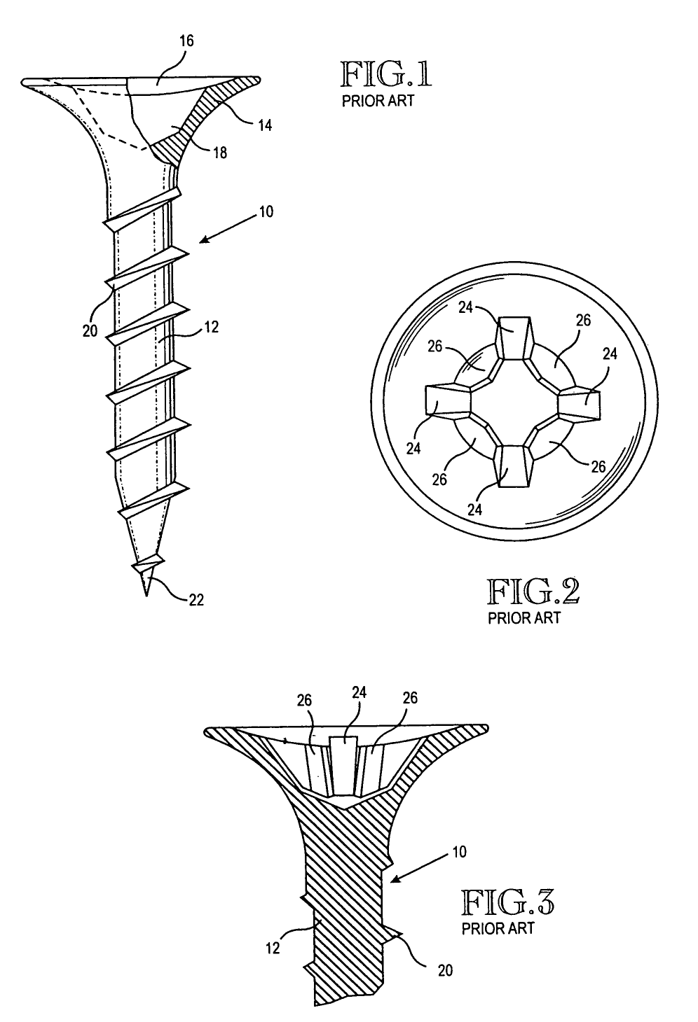

FIGS. 1-3 show a prior art wallboard screw such as the type shown by the aforementioned U.S. Pat. Nos. 5,205,694 and 5,249,882. Referring to FIG. 1, the screw 10 includes a shank 12 and a head 14. The outer end of the head 14 is cupped at 16 and a screw driver tip receiving socket 18 extends into the head 14. The shank 12 has threads 20 and a tip 22. The screw 10 may be adapted to enter a pre-drilled hole or it may be adapted to drill a hole. A screw that drills a hole is referred to as a self-tapping screw. The driver bit receiving socket has a basic conical shape and ribs and ridges 24, 26. As shown by FIG. 2, there are four grooves 24 spaced substantially about 900 apart and four ridges 26 spaced substantially about 900 apart. A common name for this type of screw is a “Phillips” screw. The screw driver bit receiving socket 18 is sized and shaped to receive a screw driver tip of a complementary size and shape.

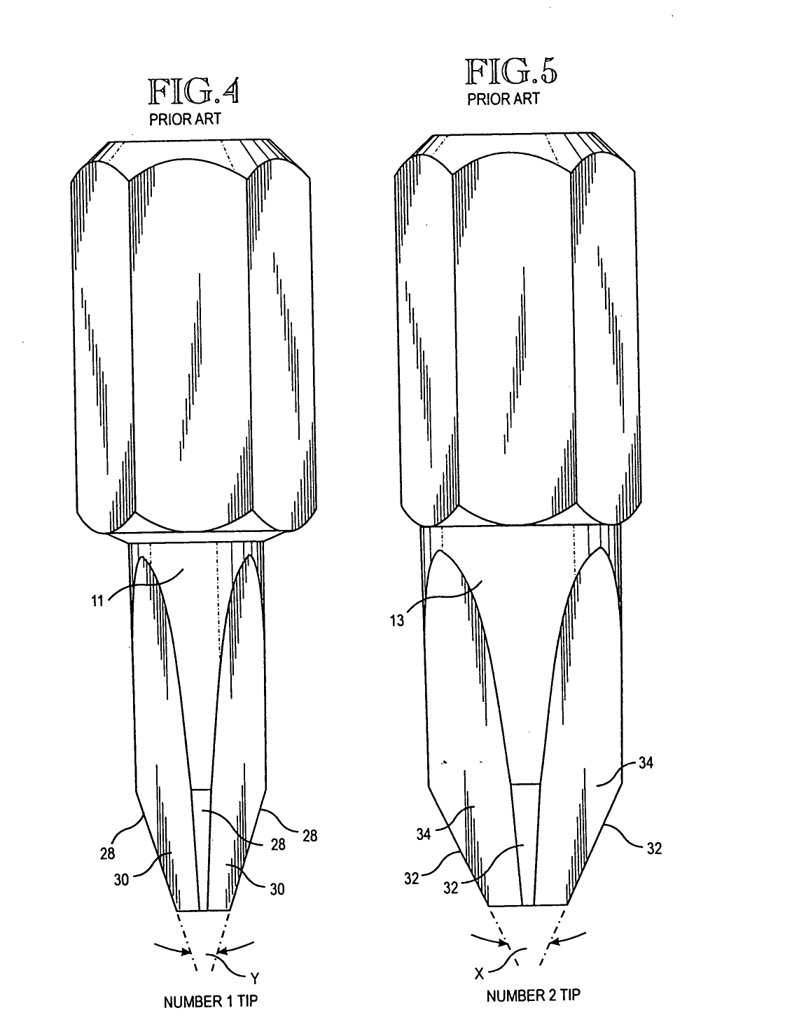

The screw driver bits come in a variety of sizes. Each tip size corresponds to a socket size in a particular screw. Screw sizes vary and the size of the screw dictates the size of the socket in the screw. That is, small screws have small sockets and larger screws have larger sockets. A small screw driver bit must be provided for driving the smaller screws and larger driver bits are provided for driving the larger screws. FIG. 4 shows a small Phillips driver tip, such as the No. 1 tip. FIG. 5 shows a Phillips No. 2 tip which is a size larger than the No. 1 tip. Referring to FIG. 4, the driver tip shown by this figure is composed of four ribs or ridges 28 separated by substantially about 90° and four grooves 30 separated by substantially about 90°. The tip ridges 28 fit in the socket grooves 24 and the tip grooves 30 receive the socket ridges 26. The larger tip shown by FIG. 5 is of the same basic construction. It includes ridges 32 spaced substantially about 90° apart and grooves 34 spaced substantially about 900 apart. The ridges 32 of the driver bit shown by FIG. 5 extend into the complementary socket grooves formed in the head of the corresponding screw. The socket ridges fit into the driver bit grooves 34.

FIG. 4 shows that the taper angle Y of the smaller size driver bit is narrower than the taper angle X of the larger size driver bit. For example, the taper angle Y of the smaller tip shown by FIG. 4 may be substantially about 25°-35° and the taper angle X of the larger 2 tip shown by FIG. 5 may be substantially about 40°-50°. In preferred form, the taper angle of a No. 1 tip is substantially about 30° and the taper angle of the No. 2 is substantially about 45°. That is, the difference of the taper of the two tips is substantially about 15°. As should be evident, the sharper angle tip can fit into a smaller socket formed in a smaller screw. The wider angle tip will fit into a larger socket formed in a larger size screw.

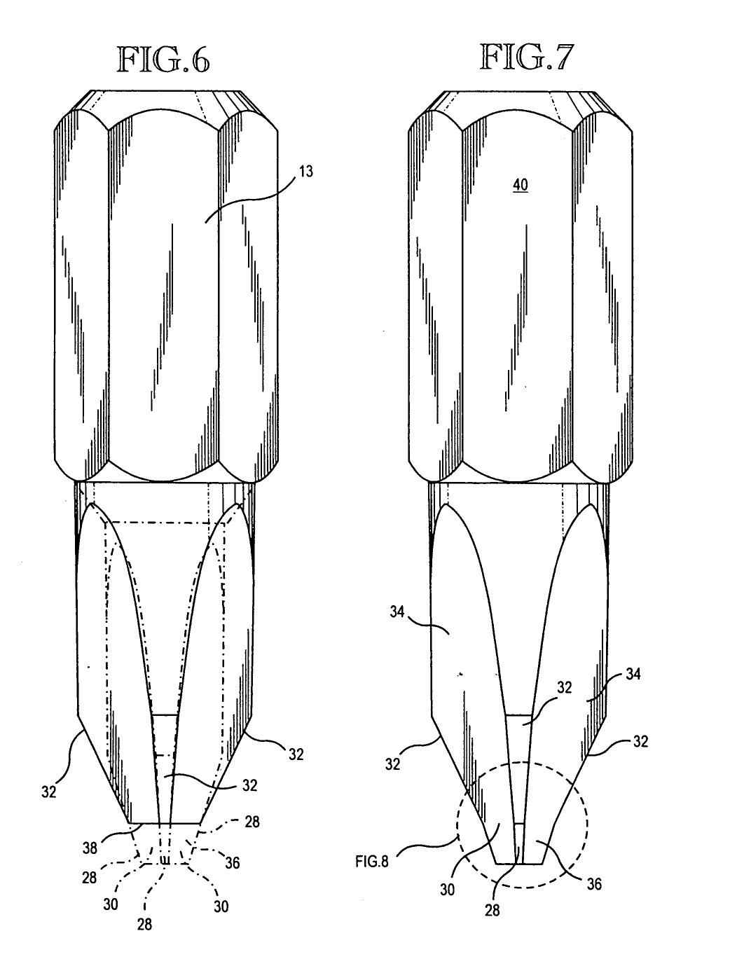

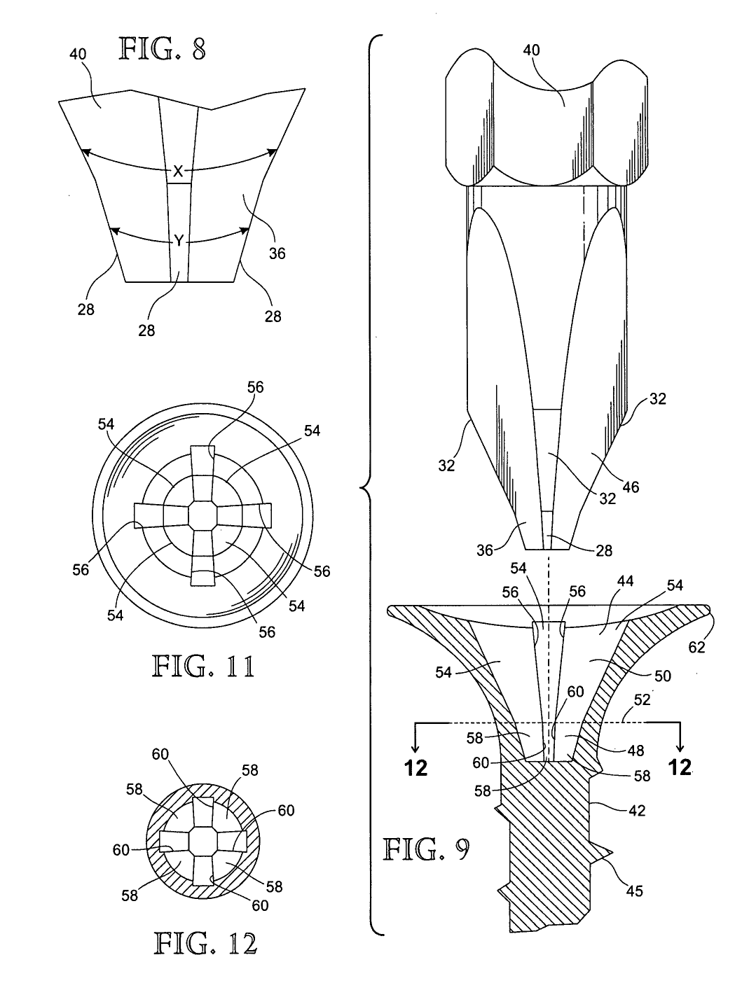

FIG. 6 shows the smaller angle tip superimposed on the larger angle tip by use of phantom lines. As can be seen by this figure, the smaller angle tip has a end portion 36 which extends beyond the end boundary 38 of the larger angle tip. When the tips are superimposed in this fashion, the ridges 28 form continuations of the ridges 32. The grooves 30 form continuations of the grooves 34. The extensions of the ridges and grooves provide the tip with a larger contact area and a larger turning capacity. Because the tip extension 36 is based on the narrow angle driver bit, it can extend into a smaller angle socket portion. FIG. 7 shows a new screw driver bit formed from the bit shown by FIG. 5 to which a tip portion 36 of the bit shown by FIG. 4 has been added. The new screw driver tip 46 can extend into a deeper socket in which the socket ribs and grooves have been extended.

FIG. 9 shows a new screw 42 that has a bi-tapered driver bit receiving socket 44 that is sized and shaped to receive the bi-tapered tip 46 of the screw driver 40. As shown by FIG. 9, the inner portion 48 of the socket 44 extends from the head of the screw into the top of the shank 42. This is possible because the inner end portion 48 of the socket 44 is narrow enough to fit within the upper end portion of the shank 42. The addition of the inner end portion 36 of the driver tip adds turning power to the driver in the form of the additional ridges and grooves. The upper portion of the driver tip and the upper portion 50 of the bi-tapered socket 44 together provide an improved turning power between the driver and the screw. The end portion 36 of the screw driver tip 46 may extend down to substantially a point. Or, the lower end shown in FIG. 9 can be extended substantially straight a longer distance than is illustrated. Of course, the socket portion 48 would have to be extended further so that its shape will match the shape of the driver tip.

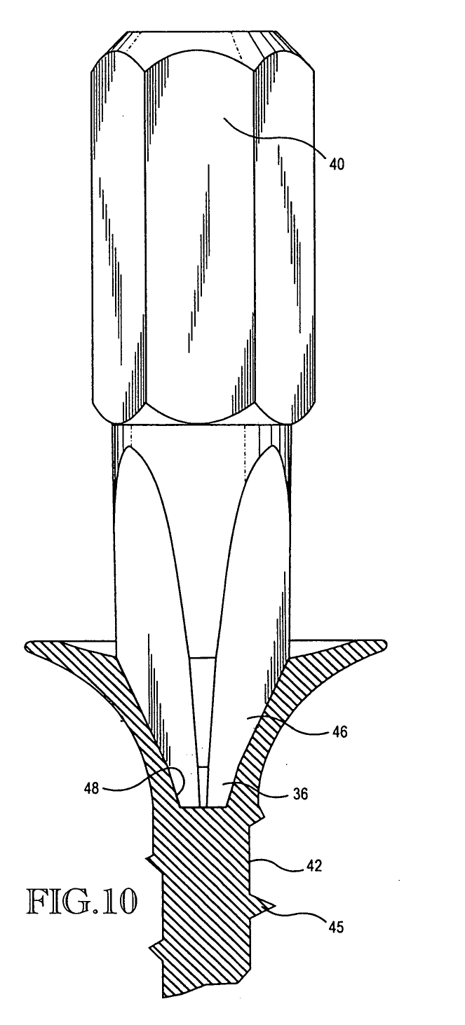

FIG. 10 shows an embodiment of the bi-tapered driver tip in an embodiment of the bi-tapered socket.

Returning to FIGS. 1 and 3, the prior art screw shown by these views has what may be referred to as a bi-tapered socket. However, in prior art screw, the inner end portion of the socket has a quite large taper angle and the outer portion has a narrower taper angle. In the prior art screw, the outer taper is substantially about 45° wherein the inner taper makes an obtuse angle of substantially about 75°. Also, the inner taper does not include any ridges or grooves which mate with the ridges and grooves at the tip end of the driver. Herein, a characteristic of the invention is that the inner taper is at a smaller angle than the outer taper and it includes ridges and grooves which mate with complementary ridges and grooves formed on the tip of the driver.

As best shown by FIG. 9, the screw 42 has a bi-tapered socket 44 comprising an outer socket portion in the head of the screw and an inner socket portion extending into the shank 43 of the screw 42. The outer socket part is above a divider line 52 and the inner socket part is below the divider line 52. The outer socket part includes four grooves 54 spaced substantially about 90° apart and four ridges 56 spaced substantially about 90° apart. The inner socket part has four grooves 58 spaced 90° apart and four ridges 60 spaced substantially about 90° apart. The grooves 54 merge into the grooves 58 and the ridges 56 merge into the ridges 60.

The illustrated embodiment of the screw has what is termed a “bugle” head. The side surfaces of the head are of concave curvature as they extend axially outwardly from the shank 43 to a rounded rim 62 that is at the outer periphery of the screw head. As shown by the aforementioned U.S. Pat. Nos. 5,205,694 and 5,249,882, when the screw is used to secure a sheet of wallboard to framing, the screw head enters into the wallboard until the rim 62 of the head is slightly below the surface of the wallboard. This places the dished or concave outer end of the screw inwardly of the flat plane formed by the outer surface of the wallboard. When joint cement is applied to the wallboard, some of it goes into the concavity formed by the outer end of the screw allowing the joint cement to have a flat outer surface where it covers the head of the screw. Some of the joint cement enters into the socket and helps secure the joint cement that is outwardly of the screw to the screw.

The illustrated embodiment is only an example of the present invention and, therefore, is non-limitive. It is to be understood that many changes in the particular structure, materials and features of the invention may be made without departing from the spirit and scope of the invention. Therefore, it is my intention that my patent rights not be limited by the particular embodiment that is illustrated and described herein but rather is to be determined from the claims that follow, interpreted in accordance with established rules of patent claim interpretation.

1-16. (canceled)

17. An improved wallboard screw comprising a head part including an outer end and a screw driver tip receiving socket, a shank part including threads, and the improvement comprising:
said outer end of the head part being dished and having a rounded rim;
said screw driver tip receiving socket being bi-tapered and adopted to receive a bi-tapered driver tip;
said bi-tapered socket including an inner socket portion having a first taper angle and an outer socket portion having a second larger second taper angle, said inner socket portion extending into the shank from the head;
said outer and inner socket portions each having alternating grooves and ridges, with the grooves in the outer socket portion merging with the grooves in the inner socket portion, and with the ridges in the outer socket portion merging with the ridges in the inner socket portion;
wherein the taper angle of the inner socket portion is substantially about 25°-35°; and
wherein the taper of the outer socket portion is substantially about 40°-50°.

18. The improved claim of 17, wherein the screw is a self-tapping screw.

19. The improvement of claim 17, wherein the taper angle of the inner socket portion is substantially about 30°.

20. The improvement of claim 17, wherein the taper angle of the outer socket portion is substantially about 45°.

21. The improvement of claim 17, wherein the screw has a bugle head.

22. A screw driver and screw, comprising:
said screw including a head part and a shank part including threads;
said outer end of the head part of the screw being dished and including a screw driver tip receiving socket;
said screw driver having a bi-tapered tip composed of an outer portion of a first taper angle and an inner portion of a second, larger taper angle, said driver tip comprising alternating ridges and grooves extending from the inner portion outwardly into the outer portion;
said screw having a bi-tapered screw driver tip receiving socket including an inner socket portion having a first taper angle and an outer socket portion having a second, larger taper angle, said inner socket portion extending into the shank from the head;
said outer and inner socket portions each having alternating grooves and ridges, with the grooves of the outer socket portion merging with the grooves in the inner socket portion, and with the ridges in the outer socket portion merging with the ridges in the inner socket portion;
wherein the ridges and grooves on the bi-tapered driver tip are complementary to the ridges and grooves to the bi-tapered socket; and
wherein the taper angle of the inner socket portion and the complementary portion of the screw driver tip have taper angles of substantially about 25°-35°.

23. The screw driver and screw combination of claim 22, wherein the screw is a self-tapping s crew.

24. The screw driver and screw of claim 22, wherein the taper angle of the inner socket portion and the complementary part of the screw driver are substantially about 30°.

25. The screw driver and screw of claim 22, wherein the taper of the outer socket portion and the complementary portion of the screw driver are substantially about 40°-50°.

26. The screw driver and screw of claim 25, wherein the taper angle of the outer socket portion and the complementary part of the screw driver are substantially about 45°.
